(19) United States
(12) Patent Application Publication
(10) Pub. No.: US 2005/0181944 A1
(43) Pub. Date: Aug. 18, 2005

(54) Copying sheet and method for creating or enhancing copying quality of a copying sheet

(75) Inventors: Lazslo Boksanyi, St. Sulpice (CH); Pierre Mury, Prilly (CH); Christophe Boissard, Monthey (CH)

Correspondence Address: FOLEY & LARDNER, 777 EAST WISCONSIN AVENUE, SUITE 3800, MILWAUKEE, WI, 53202-5308, US

(73) Assignee: Sensient Imaging Technologies S.A.

(21) Appl. No.: 11/055,471

(22) Filed: Feb. 10, 2005

(30) Foreign Application Priority Data
Feb. 17, 2004 (EP) 04405087.0

(51) Int. Cl. B41M 5/20

(52) U.S. Cl. 503/213

(57) ABSTRACT

A copying sheet comprises a first layer comprising a micro-encapsulated solvent, and at least one micro-encapsulated color agent, which is soluble in the micro encapsulated solvent; and a second layer comprising at least one additional color agent. Upon an outer influence the micro-encapsulated solvent of the first layer may penetrate the second layer at a position where the outer influence is applied. The at least one additional color agent of the second layer is at least partially releasable by the micro-encapsulated solvent

### CROSS-REFERENCE TO RELATED PATENT APPLICATIONS

European Patent Office Priority Application 04405087.0, filed Feb. 17, 2004 including the specification, drawings, claims and abstract, is incorporated herein by reference in its entirety.

### BACKGROUND

The present invention is related to the field of pressure-sensitive copying sheets, and to coatings useful for the manufacture of such copying sheets.

Traditionally, pressure-sensitive copying sheets were based on a carbon wax coating, that was applied to the back of the sheet. A major drawback of such sheets was, that the carbon wax is sensitive to unwanted rubbing-off, resulting in a relatively dirty using characteristic. Moreover, the transferred carbon is delible and can be erased with relative ease and/or bleaches out.

Moreover, pressure- and/or heat-sensitive carbonless copying sheets are currently known in the art. These systems comprise a copying sheet (often referred to as CB) and a receiving sheet (often referred to as CF), which is separate from but may be connected to the copying sheet. The copying sheet is coated with a color agent on its back, e.g. a leuco dye. The receiving sheet is coated with a developer on its side directed to the coated side of the copying sheet. Color agent and/or developer may be provided in micro-encapsulated form, whereby the micro-capsules rupture under pressure such as applied by a typewriter head or a pencil. Both the color agent and developer are mostly transparent as long as separated from each other. However, upon contact of color agent and developer, an image is produced on the receiving sheet in correspondence to where pressure has been applied. Although such systems are frequently used, a major drawback is that the intensity and/or durability of the image on the receiving paper is not sufficient for some purposes.

In order to improve the copying-intensity of such a CB sheet, an additional layer of a dry carbon printing medium (i.e. an additional carbon wax coating as mentioned above) has been proposed by GB-A-2 197 668. When a suchlike coated sheet is used with a CF sheet the resulting copy is bolder than with a conventional CB sheet. However, the resulting transcription is prone to aging, i.e. the durability of the transcription on the CF sheet is not sufficient.

It is thus an object of the present copying sheet and method to overcome one or more of the drawbacks of the mentioned prior art, especially to provide a copying sheet with enhanced quality and durability of transcription, which is easily and clean to handle.

These objects may be solved by a copying sheet, a method of creating or enhancing the copying quality of a copying sheet, a kit of parts for manufacture of a copying sheet, and a copying kit comprising at least one copying sheet as described herein.

### BRIEF DESCRIPTION OF THE DRAWINGS

FIG. 1 is a schematic, cross-sectional view of a copying sheet.

### DETAILED DESCRIPTION OF THE PREFERRED EMBODIMENTS

The present copying sheet comprises a first layer with an incorporated, especially micro-encapsulated solvent, and a second layer containing at least one color agent, wherein upon an outer influence or action, the solvent of said first layer may penetrate said second layer at the position where the outer influence or action is applied, whereby said at least one color agent of the second layer is at least partially releasable by said solvent. Preferably, said first layer is applied by means of a commonly known coating process, whereas said second layer is preferably applied in a printing process, preferably an offset printing process.

Upon release of the at least one color agent of the second layer by the solvent, the color agent of the second layer is transferred to a receiving sheet, thereby producing an image corresponding to the applied outer action. According to this basic principle, the fist layer may e.g. only comprise an incorporated, especially micro-encapsulated solvent, but no color agent. This allows for a great variability in applying the color agent just by means of the second layer. Moreover, this principle allows for a much cleaner handling because the second layer is not that sensitive to rubbing-off as e.g. a carbon-wax coating.

Alternatively, it is especially preferred to configure the microcapsules and/or the printing process, especially the offset printing process, suchlike to enable incorporation of the microcapsules into an ink comprising the color agent. Thuslike, a one-step application of both the microcapsules and the color agents is enabled, without the need an application of two separate layers.

As used herein, the outer action preferably is pressure, especially applied by a type-writer key or a pencil. However, the basic principle of the copying sheet and method is adaptable to various other outer actions such as e.g. heat. As used herein, micro-encapsulation is achieved by means of e.g. anionic microcapsules, e.g. made from urea-formaldehyde resin and/or melamine-formaldehyde resin or gelatin; the process of micro-encapsulation is well known to those of ordinary skill in the art and is disclosed e.g. in U.S. Pat. No. 4,001,140; U.S. Pat. No. 4,100,103; U.S. Pat. No. 4,552,811 (incorporated herewith by reference). It is, however, obvious to the person of routine skill in the art that the copying sheet or method may be used on the basis of any conventional carbonless copying sheet based on preferably microencapsulated solvent(s), that are known in the art.

According to a further embodiment, the first layer of the copying sheet comprises at least one additional, especially micro-encapsulated color agent, which is at least partially soluble, most preferably completely soluble in the solvent of the first layer. This additional color agent of the first layer is preferably co-micro-encapsulated with the solvent. However, it is also possible to provide separate microcapsules of solvent and color agent. The first layer of the copying sheet, especially according to this embodiment, may be the same as those known for conventional carbon-less copying sheets, e.g. comprising a leuco dye as described above. The solvent is provided in an amount sufficient to provide for transfer of both the color agents of the first layer and the second layer to a receiving sheet.

Preferred solvents and/or liquid core materials incorporated in the first layer are known by the person of ordinary skill in the art, especially chosen from the group consisting of ethyldiphenylmethane, benzylxylene, alkyl biphenyls, dialkyl phtalates, alkylated naphtalenes, partially hydrogenated terphenyls, high-boiling straight or branched chain hydrocarbons, high molecular weight esters, high molecular weight branched or linear alcohols and mixtures thereof.

According to this embodiment, an improvement of the intensity and durability of transcription of conventional carbon-less copying sheets can be achieved: the color agent of the second layer is released by the solvent incorporated in the first layer, thus enhancing the resulting intensity of transcription achievable with conventional carbon-less copying sheets, e.g. comprising a leuco dye.

In a further embodiment, the second layer of the copying sheet comprises a printed ink, e.g. a nucleophilic ink. The ink is configured suchlike to be absorbed into the paper, thus allowing clean handling of the copying sheet. Preferably, the ink does not dry significantly by evaporation of solvents or chemical crosslinking reactions or the like. The ink needs to be chemically compatible with the solvent incorporated in the first layer, i.e. no accidental color development especially of the additional color agent of the first layer should occur. Especially preferred is the use of a desensitizing ink such as those disclosed in U.S. Pat. No. 5,035,743 (incorporated herewith by reference): the nucleophilicity of such an ink on the one hand prevents the color agent of the first layer, e.g. a leuco dye, from being accidentally developed; color development thus only occurs upon contact with an especially acidic developer provided by a receiving sheet. On the other hand, the ink is chosen suchlike to liberate an additional color agent out of the second layer for enhancing transcription upon the solvent of the first layer penetrating the second layer. Preferably, the color agent of the second layer is independent from an additional developer, thus providing a means for transcription even in the absence of a receiving sheet carrying a developer; thus, conventional paper may be used for generating a transcription only depending on the color agent of the second layer.

Preferably, the ink comprises carbon black and/or other pigments as the color agent(s), at least one binder and at least one solvent; adaptation of both binder and solvent are within the routine practice of the person skilled in the art. The at least one binder is preferably chosen from phenolic resins, maleic resins, rosin-modified resins, alkylated resins, rosin ester resins or the like, or mixtures thereof. The at least one solvent is preferably chosen from mineral oils, glycols, vegetable oils, alcohols or the like, or mixtures thereof.

Such carbon black (e.g. Regal 400R Carbon Black, Cabot; or the like) and other pigments (e.g. DPP Rubine TR, Ciba; Paliogen Blue L 6495F, BASF; Heliogen Green L 9361, BASF; Red HFG, Clariant; Blue R 54, Clariant; or the like) are commonly available in various colors and may be incorporated in the ink as finely dispersed particles. According to an especially preferred embodiment, the ink comprises carbon black. The pigments are embedded within the other ingredients of the ink. For special applications, a dye might be additionally included into the ink as well.

In an especially advantageous embodiment, the second layer of the copying sheet comprises different color agents in different parts of the copying sheet. Differently colored sections of a resulting transcription may thus be easily achieved, thereby facilitating e.g. specific accentuation especially on transcription forms. For example, the transcription of a price on an order form or delivery form or a bill may be provided in a striking color, e.g. in red. Further applications in this respect are apparent to the person of routine skill in the art.

It is especially preferred, that said at least one color agent of the first layer (e.g. a leuco dye) is chosen suchlike to develop a color upon contact with an especially acidic developer, which may be provided by a receiving sheet. Moreover, but not necessarily, the color agent of the second layer may also be chosen suchlike that it's coloration gets more intense upon contact with an especially acidic developer. Especially dyes are known to be prone to a change of color depending on the pH, thus a development or enhancement of a dye-mediated color can be achieved upon contact with an especially acidic developer.

Typical developers to be used are common knowledge of the person of routine skill in the art, and are preferably chosen from the group consisting of acidic clays, acidic resins (e.g. phenolic resins) or salicylate developers (e.g. zinc salicylate developers), derivatives and salts and mixtures thereof.

Moreover, the copying sheet is also related to a method of creating or enhancing the copying quality of a copying sheet, comprising the steps of:
1. Providing a backing material, which is at least partially supplied with a first layer with an incorporated, especially micro-encapsulated solvent, and
2. At least partially applying a second layer onto said first layer, wherein the second layer comprises at least one color agent, which is at least partially releasable by said solvent of the first layer.

It is especially preferred that the first layer comprises at least one additional, preferably co-micro-encapsulated color agent, which is at least partly soluble in said solvent of the first layer.

The second layer is preferably applied in a printing process, especially an offset printing process. The offset printing process easily allows for high-quality prints in thin layer thickness, preferably of about 1 to 3 μm. Moreover, offset printing is preferred because it is the most widespread and the most economical one especially in business form printing. Additionally, typical solvents used in offset printing processes are oils, which are also good solvents for typical resins used for coating of the pigments and/or carbon black particles.

It is especially advantageous e.g. for forms or the like that the second layer is applied suchlike to comprise two or more different color agents, separated from each other. Application of different second layers beside each others can be easily achieved in commonly used printing processes such as offset printing.

Moreover, a kit of parts for manufacture of a copying sheet, is provided which comprises:
1. components, either separate or pre-mixed, for applying a first layer onto a backing layer, comprising an incorporated, especially micro-encapsulated solvent; and
2. components, either separate or premixed, for applying a second layer onto said first layer, containing at least one color agent, which is at least partially releasable by the solvent incorporated in the first layer.

Another embodiment is a copying kit, comprising at least one copying sheet as described above and at least one receiving sheet, wherein the receiving sheet comprises an especially acidic developer, which generates a color upon transfer of said at least one color agent of the first layer and/or said color agent of the second layer to the receiving sheet.

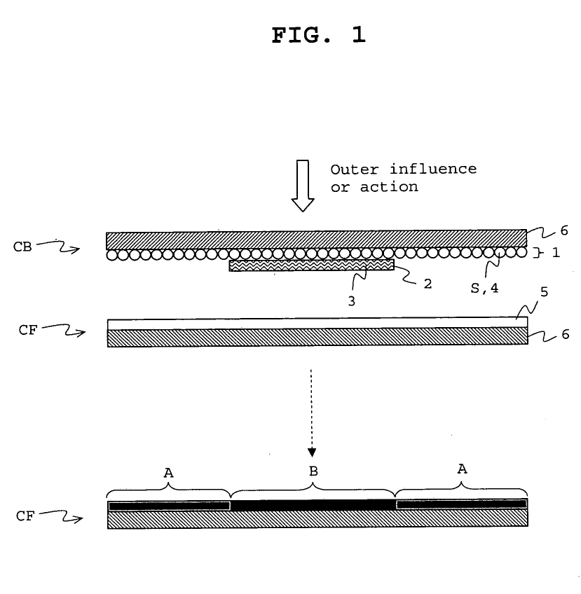

A preferred embodiment will now be described in more detail by means of FIG. 1:

According to a preferred embodiment shown in FIG. 1, the copying sheet CB comprises a backing material (e.g. paper), a first layer 1 with a preferably micro-encapsulated solvent S and a second layer 2 containing at least one color agent 3. The second layer 2 is at least partially applied onto the first layer 1.

According to the present embodiment, compositions of the first layer and the second layer are as follows:

For the backing material including the first layer, a conventional carbonless copying sheet such as Idem (ArjoWiggins) may be used.

The second layer, preferably applied in an offset printing process, comprises by means of example:

| | |
|---|---|
| 20% by weight: | carbon black (or pigment) |
| 23% by weight: | Bremapal 3000 (phenolic resin, binder; Robert Kraemer |
| | GmbH & Co) |
| 42% by weight: | Amine Polymer 2420 (Sensient; nucleophilic compound |
| | according to examples 1 and 2 of U.S. Pat. No. |
| | 5,035,743, incorporated herewith by reference) |
| 8% by weight: | Calcium carbonate (optional pigment) |
| 7% by weight: | Polypropylene glycol (solvent, viscosity controller; a |
| | suitable MW range is to be chosen depending on the |
| | r ingredients and the envisaged application) |

A corresponding receiving sheet CF comprises a backing material 6, e.g. paper, and a layer comprising an especially acidic developer 5.

In use, the copying sheet CB and the receiving sheet CF are arranged suchlike that both the backing materials 6 of copying sheet CB and receiving sheet CF are directed outwards. Upon an outer influence or action, preferably pressure applied by a typewriter head or a pencil, to the backing material 6 of the copying sheet CB, the micro-encapsulated solvent S of the first layer 1 gets partially released by rupture of the micro-capsules where the pressure is applied. The released solvent S locally penetrates into the second layer 2, thereby releasing a color agent 3 out of the second layer 2. The color agent 3 of the second layer 2 develops an image in correspondence to the applied pressure upon contact with the especially acidic developer 5 on the receiving sheet CF. If pressure is applied to a section B of the copying sheet, where a second layer 2 was added, an image is produced on the receiving sheet. In contrast, no image on the receiving sheet CF is produced in those sections A, where no second layer 2 is applied to the copying sheet CB.

In another especially preferred embodiment, the first layer additionally also comprises a color agent 4, e.g. a leuco dye. Besides this additional color agent, the formulation of the first layer remains the same as outlined above. If pressure is now applied to a section A of the copying sheet, an image is only produced on the receiving sheet CB by means of the color agent 4 of the first layer 1 getting in contact with the developer 5. However, if pressure is applied to a section B of the copying sheet CB, where an additional second layer is applied to the copying sheet CB, a more intense image is produced on the receiving sheet: The solvent S incorporated in the first layer 1 releases the color agent 3 from the second layer, and both the color agents 3 and 4 of second and first layer, respectively, are forming the image upon contact with the developer. Therefore, the second layer acts as an image enhancing layer.

For special needs, e.g. highlighting etc., different second layers 2 may be applied to different sections of the copying sheet CB. Thuslike, special colorations of the image can be easily achieved by a variation of the color agent 3 of only the second layer 2.

In one embodiment, the copying sheet (CB) may comprise a first layer (1) with an incorporated, especially micro-encapsulated solvent (S), and at least one, especially micro-encapsulated color agent (4), which is soluble in said solvent (S), and a second layer (2) containing at least one color agent (3), configured suchlike that upon an outer influence or action, preferably pressure, the solvent (S) of said first layer (1) may penetrate said second layer (2) at the position where the outer influence or action is applied, and whereby said at least one color agent of the second layer (3) is at least partially releasable by said solvent (S).

The color agent (4) of the first layer (1) may be co-micro-encapsulated with the solvent (S).

The copying sheet (CB) may be pressure-sensitive.

The second layer (2) of copying sheet (CB) may comprise a printed ink.

The ink may be nucleophilic.

The printed ink may comprise a carbon dye.

The at least one color agent (4) of the first layer (1) may be a leuco dye.

The solvent (S) of the first layer (1) may be chosen from the group consisting of ethyldiphenylmethane, benzylxylene, alkyl biphenyls, dialkyl phthalates, alkylated naphthalenes, partially hydrogenated terphenyls, high-boiling straight or branched chain hydrocarbons, high molecular weight esters, high molecular weight branched or linear alcohols and mixtures thereof.

The second layer (2) of copying sheet (CB) may comprise different color agents (3) in different parts of the copying sheet (CB).

The at least one color agent (4) of the first layer (1) and/or said color agent (3) of the second layer (2) may be chosen suchlike to develop a color upon contact with an especially acidic developer (5).

The developer (5) may be chosen from the group consisting of acidic clay, acidic resins such as phenolic resins or salicylate developers such as zinc salicylate developers, derivatives and salts and mixtures thereof.

According to another embodiment, a method of creating or enhancing the copying quality of a copying sheet (CB) may comprise the steps of:
1. Providing a backing material (6), which is at least partially supplied with a first layer (1) with an incorporated, especially micro-encapsulated solvent (S), and at least one, especially micro-encapsulated color agent (4), which is soluble in said solvent (S), and
2. At least partially applying a second layer (2) onto said first layer (1), wherein the second layer (2) comprises at least one color agent (3), which is at least partially releasable by said solvent (S) of the first layer (1).

The color agent (4) may be co-micro-encapsulated with said solvent (S).

The second layer (2) may be applied in a printing process, especially an offset printing process.

The second layer (2) may be applied suchlike to comprise two or more different color agents (3), separated from each other.

According to yet another embodiment, a kit of parts for manufacture of a copying sheet (CB) may comprise components, either separate or pre-mixed, for applying a first layer (1) onto a backing layer (6), comprising an incorporated, especially micro-encapsulated solvent (S), and at least one, especially micro-encapsulated color agent (4), which is soluble in said solvent (S); and components, either separate or premixed, for applying a second layer (2) onto said first layer (1), containing at least one color agent (3), which is at least partially releasable by the solvent (S) incorporated in the first layer (1).

According to another embodiment, copying kit, may comprise at least one copying sheet (CB) and at least one receiving sheet (CF). The receiving sheet comprises an especially acidic developer (5), which generates a color upon transfer of said at least one color agent (4) of the first layer (1) and/or said color agent (3) of the second layer (2) to the receiving sheet (CF).

1. A copying sheet comprising:
a first layer comprising a micro-encapsulated solvent, and at least one micro-encapsulated color agent, which is soluble in the micro encapsulated solvent; and
a second layer comprising at least one additional color agent, configured such that upon an outer influence the micro-encapsulated solvent of the first layer may penetrate the second layer at a position where the outer influence is applied, and whereby the at least one additional color agent of the second layer is at least partially releasable by the micro-encapsulated solvent.

2. The copying sheet of claim 1, wherein the outer influence is pressure.

3. The copying sheet of claim 1, wherein the at least one micro-encapsulated color agent of the first layer is co-micro-encapsulated with the micro-encapsulated solvent.

4. The copying sheet of claim 1, wherein the second layer comprises a printed ink.

5. The copying sheet of claim 4, wherein the printed ink is nucleophilic.

6. The copying sheet of claim 4, wherein the printed ink comprises a carbon dye.

7. The copying sheet of claim 1, wherein the at least one micro-encapsulated color agent of the first layer is a leuco dye.

8. The copying sheet of claim 1, wherein the micro-encapsulated solvent of the first layer is chosen from the group consisting of ethyldiphenylmethane, benzylxylene, alkyl biphenyls, dialkyl phthalates, alkylated naphthalenes, partially hydrogenated terphenyls, high-boiling straight or branched chain aliphatic hydrocarbons, high molecular weight esters, high molecular weight branched or linear alcohols and mixtures thereof.

9. The copying sheet of claim 1, wherein the second layer comprises different color agents in different parts of the copying sheet.

10. The copying sheet of claim 1, wherein the at least one micro-encapsulated color agent of the first layer or the at least one additional color agent of the second layer is capable of developing a color upon contact with an acidic developer.

11. The copying sheet of claim 10, wherein the acid developer is chosen from the group consisting of acidic clay, acidic resins, salicylate developers, salts and mixtures thereof.

12. The copying sheet of claim 1, wherein the at least one micro-encapsulated color agent of the first layer and the at least one additional color agent of the second layer are capable of developing a color upon contact with an acidic developer.

13. A method of creating or enhancing the copying quality of a copying sheet comprising the steps of:
providing a backing material, which is at least partially supplied with a first layer comprising a micro-encapsulated solvent, and at least one micro-encapsulated color agent which is soluble in the micro-encapsulated solvent; and
at least partially applying a second layer onto the first layer, wherein the second layer comprises at least one color agent which is at least partially releasable by the micro-encapsulated solvent of the first layer.

14. The method of claim 13, wherein the at least one micro-encapsulated color agent of the first layer is co-micro-encapsulated with the micro-encapsulated solvent.

15. The method of claim 13, wherein the second layer is applied in a printing process.

16. The method of claim 15 wherein the printing process is an offset printing process.

17. The method of claim 13, wherein the second layer comprises two or more different color agents, separated from each other.

18. A kit of parts for manufacture of a copying sheet comprising:
components for applying a first layer onto a backing layer, comprising a micro-encapsulated solvent, and at least one micro-encapsulated color agent which is soluble in the micro-encapsulated solvent; and
components for applying a second layer onto the first layer, the second layer comprising at least one color agent, which is at least partially releasable by the micro-encapsulated solvent of the first layer.

19. The kit of claim 18, wherein at least a portion of the components for applying a first layer onto a backing layer are premixed.

20. The kit of claim 18, wherein at least a portion of the components for applying a second layer onto the first layer are premixed.

21. A copying kit, comprising:
at least one copying sheet, which includes first and second layers; and
at least one receiving sheet;
wherein the receiving sheet comprises an acidic developer, which is capable of generating a color upon transfer of at least one color agent from the first layer or at least one color agent from the second layer to the receiving sheet.

22. A copying kit, comprising at least one copying sheet, which includes first and second layers; and
at least one receiving sheet;
wherein the receiving sheet comprises an acidic developer, which is capable of generating a color upon transfer of at least one color agent from the first layer and at least one color agent from the second layer to the receiving sheet.
